(19) United States
(12) Patent Application Publication
(10) Pub. No.: US 2017/0225574 A1
(43) Pub. Date: Aug. 10, 2017

(54) STRUCTURES FOR CHARGING A MULTICOPTER

(71) Applicant: QUALCOMM Incorporated, San Diego, CA (US)

(72) Inventors: Christian Oliver Thelen, San Diego, CA (US); Michael Mitrani, San Diego, CA (US)

(21) Appl. No.: 15/040,236

(22) Filed: Feb. 10, 2016

(51) Int. Cl. B60L 11/18; B64C 27/08; B64C 39/02; H02J 7/02; H02J 7/00

(52) U.S. Cl. CPC B60L 11/182; H02J 7/025; H02J 7/0042; B64C 39/024; B64C 27/08; B60L 11/1824; B64C 2201/066; B64C 2201/042

(57) ABSTRACT

Some aspects provide for a multicopter that includes a frame and a charging unit receiver configured to receive a portion of a charging unit. In some aspects, a perimeter of a cross-section of the proximal portion of the charging unit receiver may be shorter than a perimeter of a cross-section of the distal portion of the charging unit receiver. In some aspects, a perimeter of a cross-section of the distal portion of the charging unit receiver may be shorter than a perimeter of a cross-section of the proximal portion of the charging unit receiver. Some aspects provide for a charging unit that includes a frame and a multicopter receiver configured to receive a portion of the multicopter. In some aspects, a perimeter of a cross-section of the distal portion of the multicopter receiver may be shorter than a perimeter of a cross-section of the proximal portion of the multicopter receiver.

### TECHNICAL FIELD

Aspects of the present disclosure relate, generally, to a multicopter and, more particularly, to structures for charging the multicopter.

### BACKGROUND

Multicopters may be utilized in many real-world applications, which may sometimes involve automated operations performed in relatively remote locations. Multicopters sometimes receive power from a battery that requires periodic recharging. The multicopter may sometimes dock with a charging unit for recharging. The physical structures that enable the docking of the multicopter to the charging unit may have an impact on the efficiency and efficacy with which the multicopter is recharged. Accordingly, research and development directed to enhancements for such structures may improve the overall performance of the multicopters and/or their charging units.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure provides a multicopter. The multicopter may include a frame and a charging unit receiver coupled to the frame and configured to receive a portion of a charging unit. The charging unit receiver may include a distal portion and a proximal portion. A perimeter of a cross-section of the proximal portion of the charging unit receiver may be shorter than a perimeter of a cross-section of the distal portion of the charging unit receiver.

In some aspects, the present disclosure provides a charging unit for a multicopter. The charging unit may include a frame and a multicopter receiver coupled to the frame and configured to receive a portion of the multicopter. The multicopter receiver includes a distal portion and a proximal portion. A perimeter of a cross-section of the distal portion of the multicopter receiver may be shorter than a perimeter of a cross-section of the proximal portion of the multicopter receiver.

In some aspects, the present disclosure provides a multicopter. The multicopter may include a frame and a charging unit receiver coupled to the frame and configured to be receivable into a portion of a charging unit. The charging unit receiver may include a distal portion and a proximal portion. A perimeter of a cross-section of the distal portion of the charging unit receiver may be shorter than a perimeter of a cross-section of the proximal portion of the charging unit receiver.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a multicopter moving towards a charging unit according to aspects of the present disclosure.

FIG. 2 is a diagram illustrating an example of the multicopter near the charging unit according to aspects of the present disclosure.

FIG. 3 is a diagram illustrating an example of a charging unit receiver of the multicopter and a multicopter receiver of the charging unit according to aspects of the present disclosure.

FIG. 4 is a diagram illustrating examples of possible shapes for edges of the multicopter receiver of the charging unit according to aspects of the present disclosure.

FIG. 5 is a diagram illustrating an example of various components of the multicopter according to aspects of the present disclosure.

### DESCRIPTION OF SOME EXAMPLES

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, certain structures and components are shown in block diagram form in order to avoid obscuring such concepts.

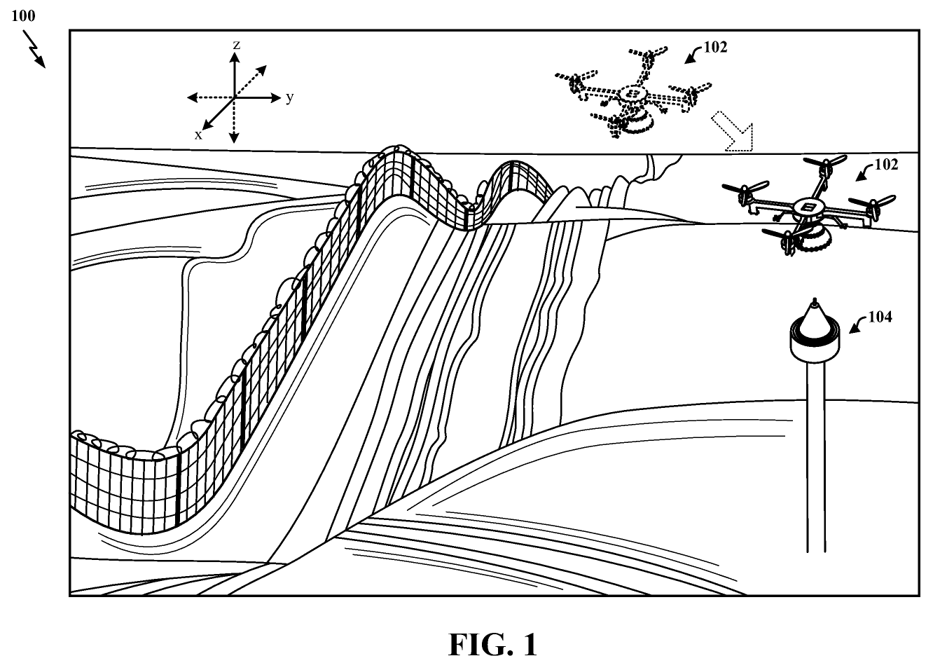

FIG. 1 is a diagram 100 illustrating an example of a multicopter 102 moving towards a charging unit 104 according to aspects of the present disclosure. In some examples, the multicopter 102 may have two or more sets of propellers. Although the example of the multicopter 102 provided herein contains three blades in each set of propellers, one of ordinary skill in the art will understand that each of the sets of propellers may have any number of blades without deviating from the scope of the present disclosure. In the example of the multicopter 102 provided herein, each of the set of propellers is located at an end portion of arms that extend away from a center portion of the multicopter. However, one of ordinary skill in the art will understand that any of the set of propellers may additionally or alternatively be positioned in other locations of the multicopter 102 without deviating from the scope of the present disclosure. One of ordinary skill in the art will understand that a multicopter may sometimes be referred to using other names (e.g., a quadcopter, a hexacopter, an octocopter, and/or various other suitable names) without deviating from the scope of the present disclosure.

In some examples, the multicopter 102 may autonomously perform operations using computer-executable code/instructions previously programmed for the multicopter 102. For instance, the multicopter 102 may be an apparatus that can perform aerial flight with minimal or no concurrent control/involvement by a human. That is, the multicopter 102 may be configured for aerial flight in the x-axis, y-axis, and/or z-axis with minimal or no concurrent control/involvement by a human. In some examples, the multicopter 102 may perform operations using commands received concurrently (e.g., in real time) from a remote command module. The multicopter 102 may also perform various operations using additional or alternative techniques and/or technologies without deviating from the scope of the present disclosure.

The multicopter 102 may be utilized in a variety of real-world applications without deviating from the scope of the present disclosure. In the example illustrated in FIG. 1, the multicopter 102 is utilized for autonomously performing operations that relate to border patrol. The multicopter 102 may perform such operations regularly throughout every day and night, thereby possibly leading to a decrease in the likelihood of illegal drugs, contraband, and/or persons crossing from one country to another country. However, the application of the multicopter 102 is not limited solely to border patrol.

In some examples, the multicopter 102 may be utilized for agricultural purposes. For instance, the multicopter 102 may autonomously monitor environment conditions (e.g., humidity, temperature, etc.) of agriculture spread across many acres. Also, the multicopter 102 may autonomously administer treatments (e.g., pesticide, insecticide, fertilizer, etc.) to agriculture spread across many acres. In some examples, the multicopter 102 may be utilized for traffic-related purposes. For instance, the multicopter 102 may be able to rapidly travel to the scene of a traffic accident and provide real-time information (e.g., video and/or audio information) to first responders (e.g., paramedics, firefighters, and/or police). In some examples, the multicopter 102 may be utilized for cargo delivery purposes. For instance, the multicopter 102 may carry cargo (e.g., a package, mail, etc.) from a warehouse to a location (e.g., a residence, a business, etc.) associated with the intended recipient of that cargo. The foregoing examples of real-world applications are not intended to limit the scope of the present disclosure. One of ordinary skill in the art will understand that the multicopter 102 may be utilized in many other real-world applications without deviating from the scope of the present disclosure.

Nevertheless, many of these real-world applications involve relatively remote locations. The multicopter 102 may sometimes need to recharge its power component (e.g., battery) using a charging unit 104. The charging unit 104 may be located throughout the relatively remote locations in which the multicopter 102 performs its operations. By having a charging unit 104 relatively nearby, the multicopter 102 may be able to spend relatively more time performing its operations rather than traveling to more distant locations to recharge.

To recharge its power component (e.g., battery), the multicopter 102 may have to dock with the charging unit 104. For example, the multicopter 102 may have to land onto the charging unit 104. The charging unit 104 may sometimes be supported by a supporting structure (e.g., a pole), as illustrated in FIG. 1, although such a supporting structure is not necessarily a requirement of the present disclosure. The physical structures used for docking by the multicopter 102 and the charging unit 104 may affect the efficiency and efficacy with which the charging unit 104 recharges the multicopter 102, as described in more thorough detail herein.

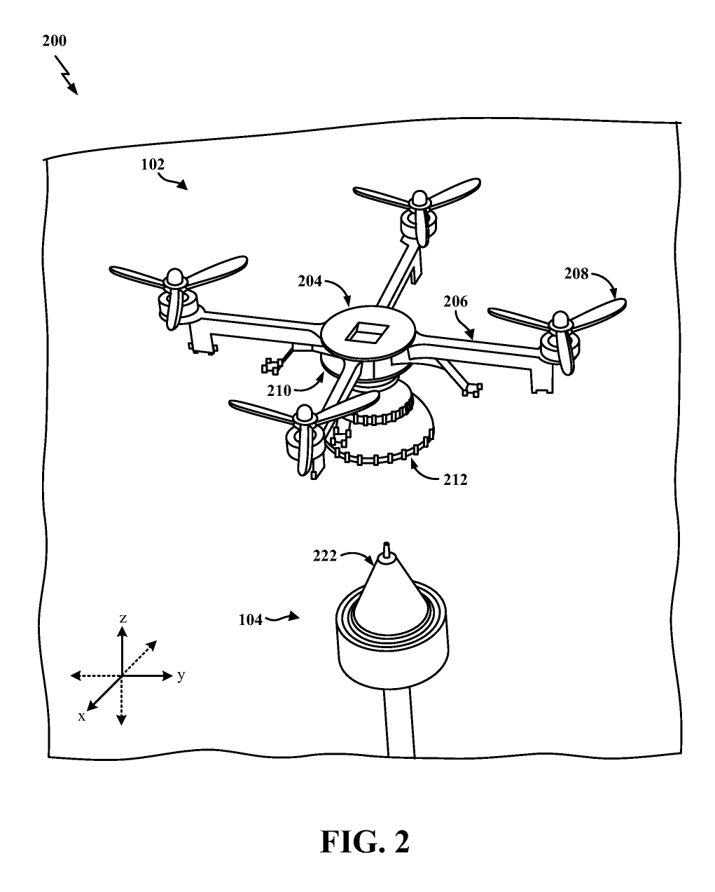

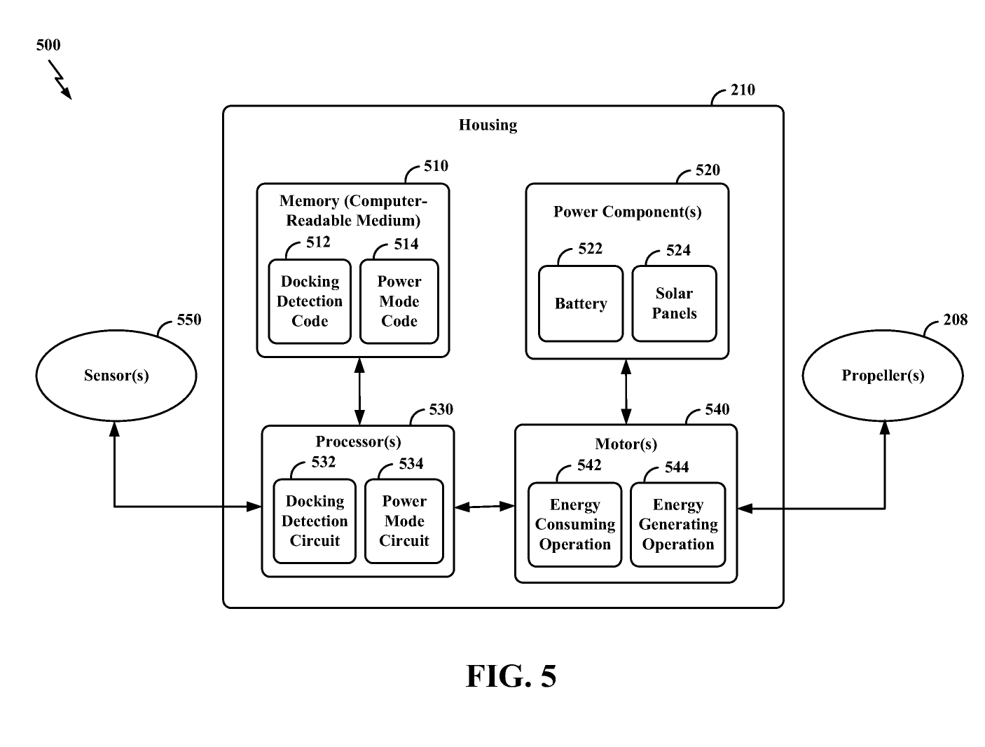

FIG. 2 is a diagram 200 illustrating an example of the multicopter 102 near the charging unit 104 according to aspects of the present disclosure. In some aspects, the multicopter 102 may include a frame 204, which may generally refer to a framework, a support structure, a core, and/or various other suitable aspects that can provide a stable, durable, and/or rigid infrastructure for one or more aspects of the multicopter 102. In some aspects, the frame 204 may include or be coupled to a plurality of arms 206. Each of the plurality of arms 206 may extend away from a center portion of the frame 204. The multicopter 102 may also include one or more propellers 208 located at an end portion of each of the plurality of arms 206. The frame 204 of the multicopter 102 may include or be coupled to a housing 210. The housing 210 may be an enclosure in which various components of the multicopter are located. The housing 210 of the multicopter 102 may include one or more motors (e.g., motor(s) 540 in FIG. 5), which may be configured to drive the rotational movement of the propellers 208. The housing 210 may also include a processor (e.g., processor 530 in FIG. 5), which may be configured to control the motor.

The housing 210 may also include a power component (e.g., power component 520 in FIG. 5), which may be a battery (e.g., battery 522 in FIG. 5) in some configurations. When the multicopter 102 is in aerial flight, the multicopter 102 may be in a power consumption mode. In the power consumption mode, the multicopter 102 provides power to the motors. When the multicopter 102 is not in aerial flight (e.g., docked with the charging unit 104), the multicopter 102 may sometimes be in a power generation mode. In the power generation mode, the multicopter 102 may use its propellers 208 to capture wind energy, and the motor of the multicopter 102 may convert the captured wind energy into electrical energy, which may be stored in the power component (e.g., battery) of the multicopter 102. Additional description pertaining to the housing 210 is provided throughout the present disclosure (e.g., with reference to FIG. 5).

The multicopter 102 may include a charging unit receiver 212. In some aspects, the charging unit receiver 212 may be coupled to the frame 204. Put another way, the frame 204 may be coupled to the charging unit receiver 212. For example, the frame 204 may be linked to, connected to, joined with, and/or otherwise similarly associated with the charging unit receiver 212. In some aspects, the charging unit receiver 212 may be integrated with the frame 204. Put another way, the frame 204 may be integrated with the charging unit receiver 212. For example, the frame 204 may be unified with, combined with, incorporated into, integrated into, and/or otherwise similarly associated with the charging unit receiver 212.

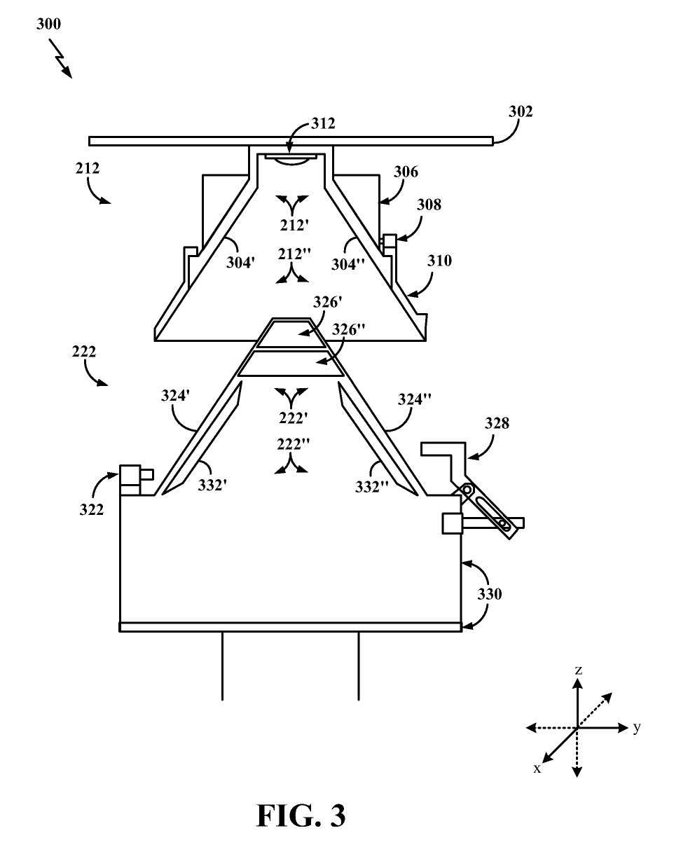

The charging unit receiver 212 of the multicopter 102 may be configured to receive at least a portion of the multicopter receiver 222 of the charging unit 104. The multicopter receiver 222 of the charging unit 104 may be configured to receive at least a portion of the charging unit receiver 212 of the multicopter 102. The term(s) ‘receive’ and/or ‘receiver’ is/are intended to be construed broadly so as to cover many suitable implementations without deviating from the scope of the present disclosure. In some aspects, a first element (e.g., a receptacle) may receive (or be a receiver of) a second element (e.g., a protrusion) when at least a portion of the second element (e.g., the protrusion) is inserted into at least a portion of the first element (e.g., the receptacle). As such, the second element (e.g., the protrusion) may be characterized as being ‘receivable into’ and/or ‘insertable into’ the first element (e.g., the receptacle). Additionally, in such aspects, the second element (e.g., the protrusion) may still be characterized as receiving (or being a receiver) of the first element (e.g., the receptacle) by virtue of the compatibility of the second element (e.g., the protrusion) with the first element (e.g., the receptacle). Accordingly, the term(s) ‘receive’ and/or ‘receiver’ are not limited to a particular physical characteristic (e.g., receptacle and/or protrusion) and therefore may be construed broadly in accordance with the description provided herein. Additional description pertaining to the charging unit receiver 212 of the multicopter 102 and the multicopter receiver 222 of the charging unit 104 is provided throughout the present disclosure, e.g., with reference to FIG. 3.

In some aspects, the charging unit 104 may include a frame 330 (e.g., as illustrated in FIG. 3), which may generally refer to a framework, a support structure, a core, and/or various other suitable aspects that can provide a stable, durable, and/or rigid infrastructure for one or more aspects of the charging unit 104. In some aspects, the multicopter receiver 222 may be coupled to the frame 330. Put another way, the frame 330 may be coupled to the multicopter receiver 222. For example, the frame 330 may be linked to, connected to, joined with, and/or otherwise similarly associated with the multicopter receiver 222. In some aspects, the multicopter receiver 222 may be integrated with the frame 330. Put another way, the frame 330 may be integrated with the multicopter receiver 222. For example, the frame 330 may be unified with, combined with, incorporated into, integrated into, and/or otherwise similarly associated with the multicopter receiver 222.

FIG. 3 is a diagram 300 illustrating an example of the charging unit receiver 212 of the multicopter 102 (e.g., as illustrated in FIGS. 1 and 2) and the multicopter receiver 222 of the charging unit 104 according to aspects of the present disclosure. With reference to FIGS. 1-3, a plate 302 may connect the charging unit receiver 212 to the multicopter 102. The charging unit receiver 212 of the multicopter 102 may have a proximal portion 212′ and a distal portion 212″. Generally, the proximal portion 212′ is closer to the multicopter 102 than the distal portion 212″. Put another way, the distal portion 212″ is further away from the multicopter 102 than the proximal portion 212′. The multicopter receiver 222 of the charging unit 104 may have a distal portion 222′ and a proximal portion 222″. Generally, the proximal portion 222″ is closer to a base (e.g., bottom/lower portion) of the frame 330 of the charging unit 104 than the distal portion 222′. Put another way, the distal portion 222′ is further away from the base (e.g., bottom/lower portion) of the frame 330 of the charging unit 104 than the proximal portion 222″.

The charging unit receiver 212 of the multicopter 102 may have various shapes without deviating from the scope of the present disclosure. The multicopter receiver 222 of the charging unit 104 may also have various shapes without deviating from the scope of the present disclosure. One of ordinary skill in the art will understand that any examples described herein with reference to the charging unit receiver 212 and/or the multicopter receiver 222 is provided for illustrative purposes and is not intended to necessarily limiting the scope of the present disclosure.

According to some aspects of the present disclosure, the charging unit receiver 212 of the multicopter 102 may have a cone, conical, conoid, cone-like, and/or similar shape. In some examples, the charging unit receiver 212 of the multicopter 102 may have one or more sloped edges 304′, 304″. In other words, one or more of the edges 304′, 304″ of the charging unit receiver 212 of the multicopter 102 may not be perfectly parallel with a horizontal (e.g., x-axis) line nor perfectly parallel with a vertical (e.g., z-axis) line. Put another way, one or more of the edges 304′, 304″ of the charging unit receiver 212 of the multicopter 102 may have a slope that includes a change in at least two dimensions (e.g., y-axis and z-axis). When the charging unit receiver 212 of the multicopter 102 has one or more sloped edges 304′, 304″, a perimeter of a cross-section of one portion (e.g., the proximal portion 212′) of the charging unit receiver 212 is shorter than a perimeter of a cross-section of another portion (e.g., the distal portion 212″) of the charging unit receiver 212.

The multicopter receiver 222 may have a shape that compliments and/or corresponds to the shape of the charging unit receiver 212 (described above). According to some aspects of the present disclosure, the multicopter receiver 222 of the charging unit 104 may have a cone, conical, conoid, cone-like, and/or similar shape. In some examples, the multicopter receiver 222 of the charging unit 104 may have one or more sloped edges 324′, 324″. In other words, one or more of the edges 324′, 324″ of the multicopter receiver 222 of the charging unit 104 may not be perfectly parallel with a horizontal (e.g., x-axis) line nor perfectly parallel with a vertical (e.g., z-axis) line. Put another way, one or more of the edges 324′, 324″ of the multicopter receiver 222 of the charging unit 104 may have a slope that that includes a change in at least two dimensions (e.g., y-axis and z-axis). When the multicopter receiver 222 of the charging unit 104 has one or more sloped edges 324′, 324″, a perimeter of a cross-section of one portion (e.g., the distal portion 222′) of the multicopter receiver 222 is shorter than a perimeter of a cross-section of another portion (e.g., the proximal portion 222″) of the multicopter receiver 222.

The examples illustrated in FIGS. 1-3 show that the multicopter 102 moves in a vertically downward direction in order to dock with the charging unit 104. In such examples, the proximal portion 212′ of the charging unit receiver 212 is located vertically above the distal portion 212″ of the charging unit receiver 212. Also in such examples, the perimeter of a horizontal cross-section (e.g., a cross-section along the x-axis) of the proximal portion 212′ of the charging unit receiver 212 is shorter than the perimeter of a horizontal cross-section (e.g., a cross-section along the x-axis) of the distal portion 212″ of the charging unit receiver 212. Further, in such examples, the perimeter of a horizontal cross-section (e.g., a cross-section along the x-axis) of the distal portion 222′ of the multicopter receiver 222 is shorter than the perimeter of a horizontal cross-section (e.g., a cross-section along the x-axis) of the proximal portion 222″ of the multicopter receiver 222. However, the examples illustrated in FIGS. 1-3 are provided for illustrative purposes are not intended to necessarily limit the scope of the present disclosure. For example, without deviating from the scope of the present disclosure, the multicopter 102 may move in a horizontal direction (e.g., instead of a vertical direction, as described above) in order to dock with the charging unit 104.

The edges 304′, 304″ of the charging unit receiver 212 may be configured to guide the multicopter receiver 222 of the charging unit 104 as the multicopter 102 approaches and attempts to dock with the charging unit 104. When the edges 304′, 304″ of the charging unit receiver 212 and the edges 324′, 324″ of the multicopter receiver 222 have complimenting sloped edges, as described in greater detail above, some flexibility and forgiveness is allowed in the vector/trajectory that the multicopter 102 uses to approach the charging unit 104. So long as the distal portion 222′ of the multicopter receiver 222 is positioned within any portion of the distal portion 212″ of the charging unit receiver 212 of the multicopter 102, the sloped edges 304′, 304″ of the charging unit receiver 212 may guide the complimenting sloped edges 324′, 324″ of the multicopter receiver 222 in a manner that results in the multicopter 102 being more proximal to the charging unit 104 and, consequently, the charging unit 104 being more proximal to the multicopter 102. Additionally, the sloped edges 324′, 324″ of the multicopter receiver 222 may help to avoid the accumulation of debris (e.g., leaves, dirt, etc.) and precipitate (e.g., rain, snow, etc.) on the multicopter receiver 222. The angled surface of the sloped edges 324′, 324″ of the multicopter receiver 222 may take advantage of the gravitational force on such debris and precipitation, thereby allowing such debris and precipitation to fall away from the multicopter receiver 222 of the charging unit 104.

In some examples, the sloped edges 304′, 304″ of the charging unit receiver 212 and/or the sloped edges 324′, 324″ of the multicopter receiver 222 may have a uniform slope (e.g., as illustrated in FIG. 3). In other words, the slope (e.g., the rate of change in one axis relative to another axis) is the same throughout the sloped edges 304′, 304″ of the charging unit receiver 212 and/or the sloped edges 324′, 324″ of the multicopter receiver 222. However, such examples shall not necessarily limit the scope of the present disclosure.

In some examples, the sloped edges 304′, 304″ of the charging unit receiver 212 and/or the sloped edges 324′, 324″ of the multicopter receiver 222 may have varying slopes. For instance, any of the sloped edges 304′, 304″, 324′, 324″ may include one or more portions that have a curve or curvature. As an example, the sloped edges 304′, 304″ of the charging unit receiver 212 may include a first edge portion and a second edge portion, wherein the slope of the first edge portion differs from the slope of the second edge portion. As another example, the sloped edges 324′, 324″ of the multicopter receiver 222 may include a first edge portion and a second edge portion, wherein the slope of the first edge portion differs from the slope of the second edge portion.

In some examples, the sloped edges 304′, 304″ of the charging unit receiver 212 and/or the sloped edges 324′, 324″ of the multicopter receiver 222 may have a uniform length (e.g., as illustrated in FIG. 3). For instance, the length may be the same for the sloped edges 304′, 304″ of the charging unit receiver 212, and/or the length may be the same for the sloped edges 324′, 324″ of the multicopter receiver 222. However, such examples are shall not be construed as necessarily limiting the scope of the present disclosure.

In some examples, the sloped edges 304′, 304″ of the charging unit receiver 212 and/or the sloped edges 324′, 324″ of the multicopter receiver 222 may have varying lengths. For instance, the sloped edges 304′, 304″, 324′, 324″ may form an irregular shape (e.g., an unsymmetrical prism) such that the lengths of two (or more) of the sloped edges 304′, 304″, 324′, 324″ vary. As an example, the sloped edges 304′, 304″ of the charging unit receiver 212 may include a first edge portion and a second edge portion, wherein the length of the first edge portion differs from the length of the second edge portion. As another example, the sloped edges 324′, 324″ of the multicopter receiver 222 may include a first edge portion and a second edge portion, wherein the length of the first edge portion differs from the length of the second edge portion.

To enable charging of the power component (e.g., battery) of the multicopter 102 by the charging unit 104, many types of technologies may be implemented without deviating from the scope of the present disclosure. A non-limiting example of such a technology is inductive charging, which may sometimes also be referred to as wireless charging. Inductive charging may utilize one or more charging coils 326′, 326″ of the charging unit 104 to deliver power to one or more charging coils 306 of the multicopter 102. The one or more charging coils 326′, 326″ of the charging unit 104 may create an alternating electromagnetic field, and the one or more charging coils 306 of the multicopter 102 take power from the electromagnetic field and convert it to electric current that can be used to power the motor of the multicopter 102 and/or be stored in the power component (e.g., battery) of the multicopter 102.

The aforementioned charging coils 306, 326′, 326″ may be located throughout various locations of the multicopter 102 and/or the charging unit 104 without deviating from the scope of the present disclosure. The diagram 300 provides one non-limiting example of how these charging coils 306, 326′, 326″ may be arranged. In some aspects, the charging unit 104 may sometimes have two sets of charging coils 326′, 326″. The first set of charging coils 326′ may be located more distal to the base of the frame 330 of the charging unit 104 than the second set of charging coils 326″. After the multicopter 102 docks with the charging unit 104, the multicopter 102 and/or charging unit 104 may determine how much inductive charge is appropriate. Based on that determined amount of inductive charge, the charging unit 104 may determine whether to use the first set of charging coils 326′ and/or the second set of charging coils 326″. For example, if the first set of charging coils 326′ can provide the appropriate amount of inductive charge to the multicopter 102, then the charging unit 104 may utilize the first set of charging coils 326′ without using the second set of charging coils 326″.

To prevent unintended separation between the multicopter 102 and the charging unit 104 (e.g., during inductive charging), the multicopter 102 and/or the charging unit 104 may utilize various securing mechanisms in some aspects. One of ordinary skill in the art will understand that various forms of securing mechanisms may be implemented without deviating from the scope of the present disclosure. In some examples, the charging unit receiver 212 of the multicopter 102 may include micro-pins 308. In some examples, the charging unit 104 may include a heavy latch 328. In some examples, the charging unit 104 may include base-locking pins 322. The base-locking pins 322 and/or the heavy latch 328 may be utilized to lock/secure the charging unit receiver 212 to the multicopter receiver 222 once the multicopter 102 docks with the charging unit 104. By securing the multicopter 102 to the charging unit 104, the likelihood of the multicopter 102 unintentionally separating from the charging unit 104 due to weather conditions (e.g., turbulent wind) may be decreased.

The multicopter 102 may have one or more portions that can collapse and/or telescope. Collapsing may refer to contracting, sliding inwards, folding inwards, folding up, and other similar aspects. Telescoping may refer to the opposite of collapsing. In other words, telescoping may refer to extending, sliding outwards, folding outwards, folding down, and other similar aspects. In some configurations, the micro-pins 308 may provide a locking mechanism for preventing telescoping (e.g., during landing). For example, the micro-pins 308 may provide a means for preventing telescoping during landing. In some aspects, the charging unit receiver 212 of the multicopter 102 may include a base portion 310 that includes sections (e.g., rings, cylinders, etc.) that may be layered on top of each other. The sections of the base portion 310 may fold onto and/or slide into one another, thereby leading to collapsing of the base portion 310. These sections of the base portion 310 may also unfold and/or slide away from one another, thereby leading to a telescoping of the base portion 310. By collapsing the base portion 310, the vertical profile of the multicopter 102 may be reduced, thereby reducing the total surface area of the multicopter 102 that may be exposed to wind and other weather conditions, which may thereby reduce the likelihood of unintended separation of the multicopter 102 and the charging unit 104.

In some circumstances, frozen precipitate may form on the multicopter receiver 222 of the charging unit 104. Frozen precipitate may include ice, snow, sleet, hail, slush, graupel, and other similar types of precipitate. Frozen precipitate may adversely affect the efficiency and/or efficacy with which the multicopter 102 docks with the charging unit 104. Frozen precipitate may also adversely affect the effectiveness of inductive charging, even if the multicopter 102 is able to dock with the charging unit 104. Various technologies and techniques may be implemented to heat any frozen precipitate that may form on the multicopter receiver 222 of the charging unit 104. For example, in some aspects, the charging unit 104 may include heating coils 332′, 332″ at various locations of the multicopter receiver 222 of the charging unit 104. One of ordinary skill in the art will understand that the specific locations of the heating coils 332′, 332″ shown in the diagram 300 is provided for illustrative purposes and shall not necessarily limit the scope of the present disclosure. The heating coils 332′, 332″ may be located at various locations of the charging unit 104 without deviating from the scope of the present disclosure.

In some circumstances, the charging unit 104 may be unable to recharge the multicopter 102. As an example, the charging unit 104 may be in the middle of the desert, where conventional utility infrastructure cannot be relied upon for power. As another example, the charging unit 104 may sometimes become temporarily inoperable and therefore unable to provide inductive charging to the multicopter 102. In such circumstances, the multicopter 102 may benefit from features that enable recharging of the power component (e.g., battery) utilizing alternative power sources. As an example, the multicopter 102 may have solar panels that enable the multicopter 102 to capture solar energy and convert it to electrical energy. As another example, the multicopter 102 may perform wind energy harvesting. More specifically, the multicopter 102 may be configured to capture wind energy, the motor may be configured to use the captured wind energy to generate electrical energy, and the power component (e.g., battery) may be configured to store the generated electrical energy. Put another way, the wind may drive rotational movement of one or more propellers 208 of the multicopter 102, and that rotational movement of the propellers 208 may drive various components in the motor to move, thereby generating kinetic energy. The motor may function as a generator, which converts the kinetic energy into electrical energy, which may subsequently be used to recharge the power component (e.g., battery) of the multicopter 102.

The manner in which the propellers 208 are oriented in space can affect the effectiveness and efficiency of wind energy harvesting. For example, the effectiveness and efficiency of wind energy harvesting may be relatively high when the propellers 208 face into the wind. Because the direction in which wind blows can sometimes change, the effectiveness and efficiency of wind energy harvesting may be adversely affected if the multicopter 102 does not adapt to changes in the wind direction. Accordingly, in some aspects, at least one or more propellers 208 of the multicopter 102 may be configured to adjust in a manner that increases wind energy capture. An increase in wind energy capture may refer to an increase in the rotational movement of the propellers 208 for a certain amount of wind traveling in a certain direction. In some other aspects, at least one of the plurality of arms 206 of the multicopter 102 may be configured to adjust in a manner that increase wind energy capture. These are non-limiting examples of adjustments that may be performed by the multicopter 102. One of ordinary skill in the art will understand that the multicopter 102 may implement various other adjustments to increase wind energy capture without deviating from the scope of the present disclosure. One of ordinary skill in the art will also understand that the charging unit 104 may also implement certain adjustments to increase wind energy capture. For example, the charging unit 104 may be configured to move (e.g., pivot, rotate, redirect, angle up/down, etc.) the multicopter 102 (while the multicopter 102 is docked with the charging unit 104) in a manner that increases wind energy capture (by the propellers 208 of the multicopter 102).

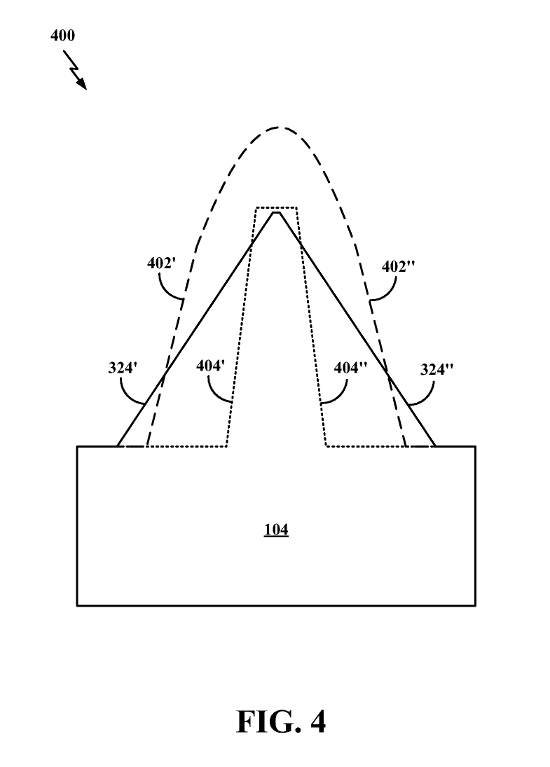

FIG. 4 is a diagram 400 illustrating examples of possible shapes for the edges of the multicopter receiver 222 of the charging unit 104 according to aspects of the present disclosure. With reference to FIGS. 1-4, as described above, the shape(s) of the edges of the multicopter receiver 222 of the charging unit 104 may compliment (e.g., correspond to) the shape(s) of the edges of the charging unit receiver 212 of the multicopter 102. Accordingly, even though certain aspects may be described herein with reference to the shape(s) of the edges of the multicopter receiver 222 of the charging unit 104, one of ordinary skill in the art will understand that complimentary (e.g., corresponding) aspects may apply with reference to charging unit receiver 212 of the multicopter 102 without deviating from the scope of the present disclosure.

Various aspects pertaining to the shapes of edges of the multicopter receiver 222 of the charging unit 104 and the shapes of edges of the charging unit receiver 212 of the multicopter 102 is provided above, e.g., with reference to sloped edges 324′, 324″, and therefore will not be repeated. In some examples, the sloped edges 324′, 324″ of the multicopter receiver 222 have a uniform slope. In some examples, the sloped edges 402′, 402″ of the multicopter receiver 222 may have varying slopes (e.g., one or more portions that have a curve or curvature). In some examples, the sloped edges 404′, 404″ of the multicopter receiver 222 may have varying lengths (e.g., of an irregular shape, such as an unsymmetrical prism). One of ordinary skill in the art will understand that the examples illustrated in the diagram 400 are provided for illustrative purposes and are not necessarily intended to limit the scope of the present disclosure.

As described in greater detail above with reference to FIGS. 1-3, in some aspects, the multicopter receiver 222 of the charging unit 104 may be received in the charging unit receiver 212 of the multicopter 102 as the multicopter 102 docks with the charging unit 104. In such aspects, the multicopter receiver 222 of the charging unit 104 may be characterized as a ‘male’ component of the docking connection between the multicopter 102 and the charging unit 104, and the charging unit receiver 212 of the multicopter 102 may be characterized as a ‘female’ component of the docking connection between the multicopter 102 and the charging unit 104, wherein the ‘male’ component is received in the ‘female’ component. However, one of ordinary skill in the art will understand that alternative configurations can exist without deviating from the scope of the present disclosure. For example, in some aspects, the charging unit 104 may have the ‘female’ component, and the multicopter 102 may have the ‘male’ component, wherein the ‘male’ component of the multicopter 102 is received in the ‘female’ component of the charging unit 104. Although some examples provided herein may describe the multicopter receiver 222 as a protrusion and the charging unit receiver 212 as a receptacle, these examples are non-limiting, because alternative examples exist within the scope of the present disclosure and may include a multicopter receiver 222 that is a receptacle and a charging unit receiver 212 that is a protrusion. Accordingly, in some aspects, a charging unit receiver 212 (e.g., a protrusion) may be configured to be receivable into (e.g., insertable into) a portion of a charging unit 104 (e.g., the multicopter receiver 222, which may be a receptacle), wherein a perimeter of a cross-section of the distal portion 212″ of the charging unit receiver 212 (e.g., the protrusion) is shorter than a perimeter of a cross-section of the proximal portion 212′ of the charging unit receiver 212 (e.g., the protrusion).

FIG. 5 is a diagram 500 illustrating an example of various components of the multicopter 102 according to aspects of the present disclosure. Although the example illustrated in FIG. 5 shows certain components of the housing 210, one of ordinary skill in the art will understand that additional or alternative components may be included in the housing 210, or elsewhere in the multicopter 102, without deviating from the scope of the present disclosure. With reference to FIGS. 1-5, in some examples, the housing 210 may include memory (e.g., computer-readable medium) 510, one or more power components 520, one or more processors 530, and one or more motor(s) 540. The processor(s) 530 may receive information from various sensor(s) 550, which may include the camera 312. Additional or alternative sensor(s) 550 may include radar detectors, infrared detectors, and/or other suitable sensors.

While the multicopter 102 is in aerial flight, the motor(s) 540 performs energy consuming operations 542, which may include consuming power from the battery 522 and/or solar panels 524 of the power component(s) 520 of the multicopter 102 to drive the rotational movement of the propellers 208 of the multicopter 102. The sensor(s) 550 may be utilized to guide the movement of the multicopter 102 as the multicopter 102 navigates its way to the charging unit 104. The sensor(s) 550 may be utilized to determine whether the multicopter 102 has successfully docked with the charging unit 104. For example, the docking detection circuit 532 of the processor(s) 530 may execute docking detection code 512 stored in the memory (e.g., computer-readable medium) 510, and the docking detection code 512 may instruct the docking detection circuit 532 of the processor(s) 530 to use the information from the sensor(s) 550 to determine whether the multicopter 102 has successfully docked with the charging unit 104.

After the detection of successful docking with the charging unit 104, the multicopter 102 may switch its power mode from a power consumption mode to a power generation mode. For example, the processor(s) 530 may utilize a power mode circuit 534 to execute power mode code 514 stored in the memory (e.g., computer-readable medium) 510, and the power mode code 514 may instruct the power mode circuit 534 to alter the operation of the motor(s) 540 from an energy consuming operation 542 to an energy generating operation 544. As described, the multicopter 102 may perform wind energy harvesting. More specifically, the multicopter 102 may be configured to capture wind energy, the motor(s) 540 may be configured to use the captured wind energy to generate electrical energy, and the power component(s) 520 (e.g., battery 522) may be configured to store the generated electrical energy. Put another way, the wind may drive rotational movement of one or more propellers 208 of the multicopter 102, and that rotational movement of the propellers 208 may drive various components in the motor(s) 540 to move, thereby generating kinetic energy. The motor(s) 540 may convert the kinetic energy into electrical energy, which may subsequently be used to recharge the power component(s) 520 (e.g., battery 522) of the multicopter 102.

As described in greater detail (e.g., with reference to FIG. 3), the manner in which the propeller(s) 208 are oriented in space can affect the effectiveness and efficiency of wind energy harvesting. Accordingly, in some aspects of the present disclosure, the processor(s) 530 may further utilize the power mode circuit 534 to execute power mode code 514 stored in the memory (e.g., computer-readable medium) 510, and the power mode code 514 may further instruct the power mode circuit 534 to adjust one or more components (e.g., propellers 208, arms 206, etc.) of the multicopter 102 in order to increase wind energy capture.

In accordance with various aspects of the disclosure, an element, or any portion of an element, or any combination of elements may be implemented with a processing system that includes one or more processors 530. The processing system may be implemented with a bus architecture, which may include a bus. The bus may include any number of interconnecting buses and bridges depending on the specific application of the processing system and the overall design constraints. The bus may link together various circuits including one or more processors 530, a memory (e.g., computer-readable media) 510, one or more power components 520, and/or one or more motor(s) 540. The bus may also link various other circuits, such as timing sources, peripherals, voltage regulators, and power management circuits.

The processor(s) 530 may be responsible for managing the bus and general processing, including the execution of software stored on the memory (e.g., computer-readable medium) 510. Examples of the one or more processors 530 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The memory (e.g., computer-readable medium) 510 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory (e.g., computer-readable medium) 510 may also include, by way of example, a carrier wave, a transmission line, and any other suitable medium for transmitting software and/or instructions that may be accessed and read by a computer. The memory (e.g., computer-readable medium) 510 may reside in the processing system, external to the processing system, or distributed across multiple entities including the processing system. The software, when executed by the processor(s) 530, may cause the processing system to perform the various functions described herein.

One of ordinary skill in the art will also understand that the multicopter 102 may include alternative and/or additional features without deviating from the scope of the present disclosure. Those skilled in the art will recognize how best to implement the described functionality presented throughout this disclosure depending on the particular application and the overall design constraints imposed on the overall system.

The description herein is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A multicopter comprising:
a frame; and
a charging unit receiver coupled to the frame and configured to receive a portion of a charging unit, wherein the charging unit receiver comprises a distal portion and a proximal portion, and wherein a perimeter of a cross-section of the proximal portion of the charging unit receiver is shorter than a perimeter of a cross-section of the distal portion of the charging unit receiver.

2. The multicopter of claim 1, wherein the charging unit receiver further comprises one or more edges configured to guide the portion of the charging unit from the distal portion of the charging unit receiver to the proximal portion of the charging unit receiver.

3. The multicopter of claim 2, wherein the one or more edges comprise one or more sloped edges.

4. The multicopter of claim 3, wherein the one or more sloped edges comprise a uniform slope.

5. The multicopter of claim 3, wherein the one or more sloped edges comprise a first edge portion and a second edge portion, wherein a slope of the first edge portion differs from a slope of the second edge portion.

6. The multicopter of claim 3, wherein the one or more sloped edges comprise a uniform length.

7. The multicopter of claim 3, wherein the one or more sloped edges comprise a first edge portion and a second edge portion, wherein a length of the first edge portion differs from a length of the second edge portion.

8. The multicopter of claim 1, wherein the charging unit receiver comprises a component configured for charging of the multicopter by the charging unit.

9. The multicopter of claim 8, wherein the component comprises one or more charging coils configured for inductive charging of the multicopter by the charging unit.

10. The multicopter of claim 1, further comprising one or more securing mechanisms configured to secure the multicopter to the charging unit.

11. The multicopter of claim 1, wherein the charging unit receiver is integrated with the frame.

12. A charging unit for a multicopter, the charging unit comprising:
a frame; and
a multicopter receiver coupled to the frame and configured to receive a portion of the multicopter, wherein the multicopter receiver comprises a distal portion and a proximal portion, and wherein a perimeter of a cross-section of the distal portion of the multicopter receiver is shorter than a perimeter of a cross-section of the proximal portion of the multicopter receiver.

13. The charging unit of claim 12, wherein the multicopter receiver further comprises one or more edges configured to guide the portion of the multicopter from the distal portion of the multicopter receiver to the proximal portion of the multicopter receiver.

14. The charging unit of claim 13, wherein the one or more edges comprise one or more sloped edges.

15. The charging unit of claim 14, wherein the one or more sloped edges comprise a uniform slope.

16. The charging unit of claim 14, wherein the one or more sloped edges comprise a first edge portion and a second edge portion, wherein a slope of the first edge portion differs from a slope of the second edge portion.

17. The charging unit of claim 14, wherein the one or more sloped edges comprise a uniform length.

18. The charging unit of claim 14, wherein the one or more sloped edges comprise a first edge portion and a second edge portion, wherein a length of the first edge portion differs from a length of the second edge portion.

19. The charging unit of claim 12, further comprising a component configured for charging the multicopter.

20. The charging unit of claim 19, wherein the component comprises one or more charging coils configured for inductive charging of the multicopter.

21. The charging unit of claim 12, further comprising one or more securing mechanisms configured to secure the multicopter to the charging unit.

22. The multicopter of claim 12, wherein the multicopter receiver is integrated with the frame.

23. A multicopter comprising:
a frame; and
a charging unit receiver coupled to the frame and configured to be receivable into a portion of a charging unit, wherein the charging unit receiver comprises a distal portion and a proximal portion, and wherein a perimeter of a cross-section of the distal portion of the charging unit receiver is shorter than a perimeter of a cross-section of the proximal portion of the charging unit receiver.

24. The multicopter of claim 23, wherein the charging unit receiver further comprises one or more edges configured to guide the portion of the charging unit from the distal portion of the charging unit receiver to the proximal portion of the charging unit receiver.

25. The multicopter of claim 24, wherein the one or more edges comprise one or more sloped edges.

26. The multicopter of claim 25, wherein the one or more sloped edges comprise a uniform slope, and wherein the one or more sloped edges comprise a uniform length.

27. The multicopter of claim 25, wherein the one or more sloped edges comprise a first edge portion and a second edge portion, wherein a slope of the first edge portion differs from a slope of the second edge portion.

28. The multicopter of claim 25, wherein the one or more sloped edges comprise a first edge portion and a second edge portion, wherein a length of the first edge portion differs from a length of the second edge portion.

29. The multicopter of claim 23, wherein the charging unit receiver comprises a component configured for charging the multicopter by the charging unit.

30. The multicopter of claim 23, wherein the charging unit receiver is integrated with the frame.
